(19) United States
(12) Patent Application Publication
(10) Pub. No.: US 2012/0124559 A1
(43) Pub. Date: May 17, 2012

(54) Performance Evaluation System

(76) Inventor: Shankar Narayana Kondur, Santa Clara, CA (US)

(21) Appl. No.: 13/339,375

(22) Filed: Dec. 29, 2011

Related U.S. Application Data
(63) Continuation-in-part of application No. 12/039,756, filed on Feb. 29, 2008, now abandoned.

(30) Foreign Application Priority Data
Aug. 21, 2007 (IN) 1866/CHE/2007

(51) Int. Cl. G06F 9/44; G06F 15/16

(52) U.S. Cl. 717/125

(57) ABSTRACT

A computer implemented method and system for concurrently evaluating performance of multiple users in one or more tests provides a performance evaluation platform that is accessible to a client application on each of multiple client devices via a network. The client application manages interaction of the users with the performance evaluation platform via the network. The client application, in communication with the performance evaluation platform, configures an adaptive test environment at each of the client devices of the users based on one or more tests selected by the users. The client application on each of the client devices loads the selected tests from the performance evaluation platform and transmits solution responses to the selected tests acquired from the users to the performance evaluation platform. The performance evaluation platform configures processing elements for concurrently processing the solution responses and concurrently evaluates the performance of the users in the selected tests.

### CROSS REFERENCE TO RELATED APPLICATIONS

This is a continuation-in-part application of non-provisional patent application Ser. No. 12/039,756, titled “Method And System For Compilation And Execution Of Software Codes” filed on Feb. 29, 2008 in the United States Patent and Trademark Office, which claims the benefit of non-provisional patent application number 1866/CHE/2007, titled “Method And System For Compilation And Execution Of Software Codes” filed on Aug. 21, 2007 in the Indian Patent Office.

The specifications of the above referenced patent applications are incorporated herein by reference in their entirety.

### BACKGROUND

The computer implemented method and system disclosed herein, in general, relates to a system for evaluating performance of users in one or more tests in addition to methods for compiling and executing a software code during testing of programming skills of a user. More particularly, the computer implemented method and system disclosed herein relates to concurrent evaluation of the performance of multiple users in one or more tests in addition to concurrent compilation and execution of multiple software codes in programming based tests.

Conventional testing platforms for evaluating the performance of users have typically been confined to performing testing in a specific knowledge domain, thereby requiring users to register at multiple different testing platforms for testing their skills across multiple knowledge domains. Therefore, there is a need for a testing platform that can adapt testing to newer technologies and knowledge domains. Consider an example where a new programming language created for a niche technology may be found applicable across multiple knowledge domains and applications, thereby qualifying knowledge of the programming language as an essential job skill This requires a testing platform that provides a testing framework for evaluating the proficiency of multiple users in the new programming language. Moreover, the programming language may require new file formats, testing environments, etc. Since the introduction of the programming language to the public domain may be recent, it is often difficult for conventional testing platforms to design testing frameworks that meet the additional requirements of the new programming language. Furthermore, there is a need for a flexible testing platform which can seamlessly integrate features of multiple different versions and formats developed by third party software developers to a particular testing methodology and framework. Moreover, the testing environments provided by conventional testing platforms are typically preconfigured with fixed settings and user interfaces that allow limited scope for modification based on the preferences of the user.

Furthermore, for evaluating the programming skills of a user, the testing platforms typically need to compile and execute software codes before they can perform the evaluation of the quality of the software code. However, conventional testing platforms are constrained by an inability to process multiple software codes quickly. For example, in the existing methods of compiling a software code, a compiler parses the software code, links the parsed software code with common libraries and system libraries, and creates an executable binary output of the software code. The software codes from multiple users are compiled separately with the above mentioned steps of parsing, linking, and creating executable binary outputs. The overheads for compilation and execution of these software codes increase with an increase in the number of software codes.

Loading and parsing of common libraries, system libraries, and header files for every compilation process increases the compilation time. Further, handling multiple requests for compilation may not be efficient. Therefore, a standard compiler may not achieve a large number of compilations concurrently with limited resources. The above mentioned limitations increase with an increase in the number of compilation requests.

Hence, there is a long felt but unresolved need for a computer implemented method and system that can flexibly adapt testing of one or more users with newer technologies across multiple knowledge domains. Moreover, there is a need for a computer implemented method and system that concurrently evaluates performance of multiple users in one or more tests of different types in different knowledge domains to optimize the time taken for evaluation of the performance of multiple users in these tests. Furthermore, there is a need for a computer implemented method and system that achieves a large number of compilations concurrently with limited resources, handles multiple compilation and execution requests efficiently, and performs a faster execution of multiple software codes, for enabling a faster evaluation of programming skills of multiple users.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above mentioned need for flexibly adapting testing of one or more users with newer technologies across multiple knowledge domains. The computer implemented method and system disclosed herein also addresses the above mentioned need for concurrently evaluating performance of multiple users in one or more tests of different types in different knowledge domains to optimize the time taken for evaluation of the performance of multiple users in these tests.

The computer implemented method and system for concurrently evaluating performance of multiple users in one or more tests disclosed herein, provides a performance evaluation platform accessible by multiple client devices of multiple users via a network. The performance evaluation platform hosts multiple tests across multiple knowledge domains. The computer implemented method and system disclosed herein also provides a client application on each of the client devices of the users for managing interaction of each of the users with the performance evaluation platform via the network. One or more of the users select one or more of multiple tests hosted by the performance evaluation platform via a graphical user interface (GUI) provided by the client application on each of the client devices of the users.

The client application on each of the client devices of the users establishes a connection with the performance evaluation platform via the network. The client application transmits requests querying availability of the performance evaluation platform for triggering initiation of the selected tests. The client application receives connection parameters from the performance evaluation platform via the network for establishing the connection with the performance evaluation platform, on confirming availability of the performance evaluation platform. Furthermore, the performance evaluation platform continually monitors requests from the client application on each of the client devices, for example, for establishing a connection with the client devices, for concurrent processing of solution responses acquired from the users, etc. As used herein, the term “solution response” refers to an answer or a response provided by a user to a particular question or a problem contained in a test.

The client application, in communication with the performance evaluation platform via the network, configures an adaptive test environment at each of the client devices of the users based on the selected tests and each user's preferences. As used herein, the term “adaptive test environment” refers to a test environment that can be configured to accommodate specific features, settings, file formats, software components, etc., necessary for conduction of a particular type of test on a client device. The performance evaluation platform validates user credentials of the users during the configuration of the adaptive test environment at each of the client devices of the users by the client application. In an embodiment, the client application automatically loads plug-in components from the performance evaluation platform via the network based on the selected tests during configuration of the adaptive test environment at each of the client devices.

The client application loads the selected tests from the performance evaluation platform in the configured adaptive test environment via the network. In an embodiment, the performance evaluation platform sets a time duration for one or more of the selected tests. The client application triggers a timer on initiation of the time duration set by the performance evaluation platform for the selected tests for timing the performance of the each of the users in the selected tests.

The client application on each of the client devices of the users acquires and transmits solution responses to the selected tests from the users to the performance evaluation platform via the network. The performance evaluation platform configures processing elements for concurrently processing the solution responses acquired from the users based on the selected tests. The processing elements are, for example, threads, child processes, etc. The performance evaluation platform spawns multiple forked child processes or multiple threads for the concurrent processing of the solution responses acquired from the users. In an embodiment, the performance evaluation platform adaptively renders questions in the selected tests based on a preliminary set of solution responses acquired from the users.

The performance evaluation platform concurrently evaluates the performance of each of the users in the selected tests based on the concurrent processing of the solution responses. The performance evaluation platform first loads the acquired solution responses in a request queue. The performance evaluation platform parses the acquired solution responses in the request queue for procuring information on the selection of the tests hosted by the performance evaluation platform. The performance evaluation platform classifies the parsed solution responses based on the procured information on the selection of the tests. The performance evaluation platform transfers the classified solution responses to solution processing queues associated with the selected tests. The performance evaluation platform analyzes the classified solution responses in the associated solution processing queues for assigning an evaluation score to each of the classified solution responses based on evaluation criteria. The evaluation criteria for generation of evaluation scores comprise, for example, time duration for completion of the selected tests by each of the users, accuracy of the solution responses acquired from each of the users, etc.

The performance evaluation platform generates evaluation scores for each of the users based on the evaluation criteria and transmits the generated evaluation scores to the client devices of the users via the network. In an embodiment, the performance evaluation platform computes a relative score based on the generated evaluation scores of each of the users for providing a comparative assessment of the performance of each of the users in the selected tests. The performance evaluation platform stores the solution responses acquired from the users and the evaluation scores generated on concurrent evaluation of the performance of each of the users in the selected tests, in a database of the performance evaluation platform for progressively tracking the performance of each of the users in the selected tests over a period of time.

Furthermore, the computer implemented method and system disclosed herein addresses the above mentioned need for achieving a large number of compilations concurrently with limited resources, handling multiple requests efficiently, and performing a faster execution of multiple software codes for enabling a faster evaluation of programming skills of multiple users. As used herein, the term “software codes” refers to computer programs written in a specific programming language, for example, C, C++, etc.

A separate thread is provided on a virtual machine (VM) server in the performance evaluation platform to listen to broadcasts from multiple client processes requesting for the availability of the VM server for compiling and executing multiple software codes. The VM server then broadcasts VM server information to the requesting client processes. When a client process obtains the VM server information, a client socket of the client device sends a connection request to the VM server. A VM server socket listens to the incoming connection request from the client process. A request dispatcher transmits requests to the VM server. When the connection is established between the VM server and the client process, the incoming requests from the client process to the VM server is stacked in a request queue to be handled. The requests from the client processes are, for example, for compiling and executing the software codes submitted by the users. A request handler present in the VM server handles the requests stacked in the request queue. A request handler thread pool takes and handles the requests from the request queue. The handled requests are stacked as run requests in a separate run request queue. A response queue is provided on the VM server to collect the responses to be transmitted to the client processes. The responses to the requests from the client processes are, for example, executable binary formats of the software codes or outputs generated by executing the software codes. The executable binary format of each of the software codes is loaded on a file system for further executions. The response handler provided on each client device handles the response from the VM server.

The computer implemented method and system disclosed herein uses a compiler. The compiler uses a system file cache and a binary cache that are maintained for each client process. The common libraries, the system libraries, and the header files required for each compilation are stored in the system file cache. The object files or class files obtained after each compilation by the compiler are stored in the binary cache. During the compilation of the software code, if a required header or a library is not available on the system file cache, the respective header or library file is loaded from a file system to the system file cache. The header or library file stored in the system file cache is used for current and subsequent compilations. If the source file of the software code is not modified since the last compilation, then the object file or the class file stored in the binary cache is used for compilation. The binary cache is updated with object files and class files generated with every new compilation. The libraries and headers stored in the system file cache and the object files and class files stored in the binary cache are linked to generate the required executable of the software code.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 exemplarily illustrates a computer implemented system for handling multiple compilation requests, compiling, and executing multiple software codes.

FIG. 2 exemplarily illustrates a first computer implemented method for compiling and executing multiple software codes using multiple forked child processes.

FIG. 3 exemplarily illustrates a second computer implemented method for compiling and executing multiple software codes using multiple threads.

FIG. 4 illustrates a computer implemented method for concurrently evaluating performance of multiple users in one or more tests.

FIG. 5 illustrates a computer implemented system for concurrently evaluating performance of multiple users in one or more tests.

FIG. 6 exemplarily illustrates the architecture of a computer system employed for concurrently evaluating performance of multiple users in one or more tests.

FIG. 7 exemplarily illustrates a high level schematic diagram of a computer implemented system for concurrently evaluating the performance of multiple users in multiple tests.

### DETAILED DESCRIPTION OF THE INVENTION

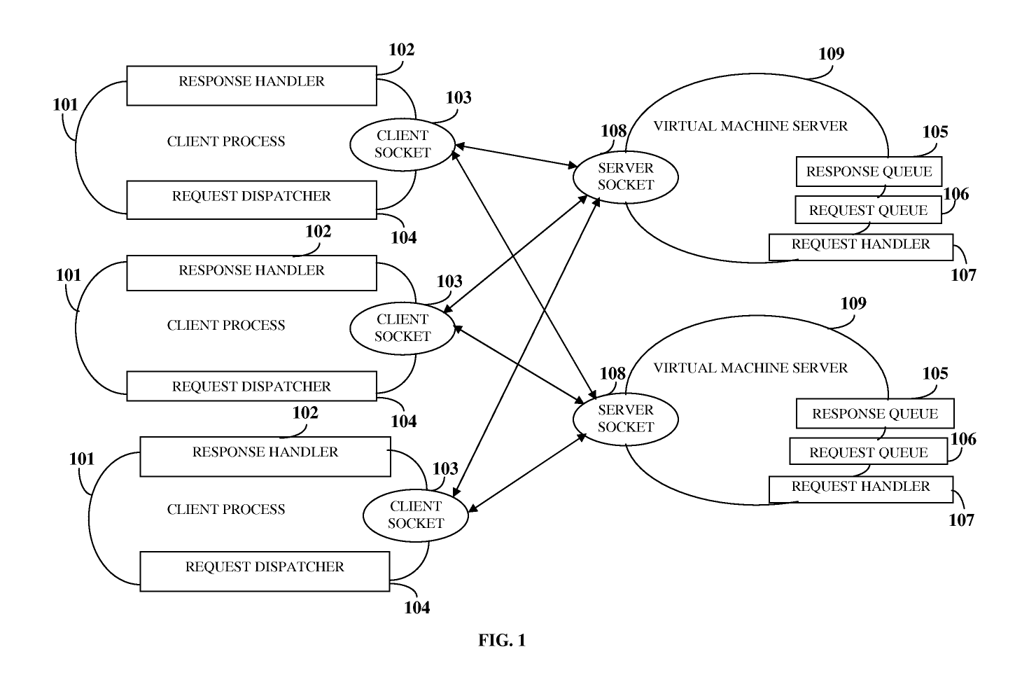

FIG. 1 exemplarily illustrates a computer implemented system for handling multiple compilation requests, compiling, and executing multiple software codes. As used herein, the term “software codes” refers to computer programs written in a specific programming language, for example, C, C++, etc. Using client processes 101, software codes created on client devices by multiple users are transmitted to a virtual machine (VM) server 109 for further compilation, execution, and evaluation of the software codes. The client devices comprise, for example, personal computers, laptops, mobile communication devices, tablet computing devices, personal digital assistants, etc. Each user's requests for compilation and execution of the software codes are generated by the corresponding client process 101 and transmitted to the VM server 109. The VM server 109 comprises a request queue 106, a request handler 107, a response queue 105, and a VM server socket 108. The VM server 109 provides VM server information to each of the client processes 101. The VM server information is transmitted between the VM server socket 108 and client sockets 103 of the users' client devices. The VM server information comprises, for example, the type of VM server 109, details of a listening port of the VM server 109, and a hostname of the VM server 109. A separate thread is provided on the VM server 109 to listen to broadcasts from the client processes 101 requesting for the availability of the VM server 109. The VM server 109 then broadcasts the VM server information to the client processes 101.

When a client process 101 obtains the VM server information from the VM server 109, a client socket 103 of the client device sends a connection request to the VM server 109. The VM server socket 108 of the VM server 109 listens to the incoming connection request from the client process 101. A request dispatcher 104 transmits requests from the client process 101 to the VM server 109. The VM server socket 108 is configured to accept connections from multiple client processes 101. When the connection is established between the VM server 109 and the client process 101 on the client device, the incoming requests from the client process 101 to the VM server 109 are stacked in the request queue 106 of the VM server 109. The requests from the client processes 101 are, for example, for compiling and executing software codes submitted by the users. Multiple requests to the VM server 109 may be issued from a single client process 101 or multiple client processes 101. The request handler 107 present in the VM server 109 handles the requests stacked in the request queue 106. The requests are taken from the request queue 106 and handled by a request handler thread pool or a request handling set of forked child processes. The handled requests are stacked as run requests in a separate run request queue. Since the run task of the run requests can be time intensive, the run requests are handled by a separate run request handler thread pool or a run request handling set of forked child processes. The request handler thread pool and the run request handler thread pool are provided separately to avoid exhaustion of threads while handling multiple compilation requests.

The response queue 105 of the VM server 109 collects responses to be transmitted to the client processes 101. The responses to the requests from the client processes 101 are, for example, executable binary formats of the software codes or outputs obtained by executing the software codes. A binary cache in the VM server 109 stores object and class files, wherein the object and class files are generated by compiling the software codes. The response handler 102 provided on each of the client processes 101 handles the responses from the VM server 109. In an embodiment, a single VM server 109 is employed for compilation and execution of the software codes. In another embodiment, multiple VM servers 109 are employed for compilation and execution of the software codes.

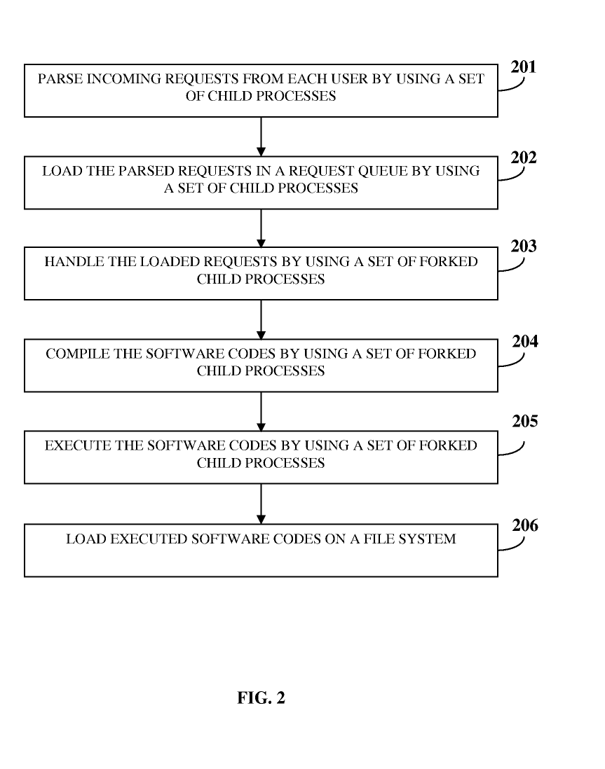

FIG. 2 exemplarily illustrates a first computer implemented method for compiling and executing multiple software codes using multiple forked child processes. The client processes 101 broadcast requests for availability of the VM server 109, as exemplarily illustrated in FIG. 1, for compiling the software codes. Through a listening port, the VM server 109 continually listens to the broadcasts of requests from the client processes 101. The VM server 109 sends the VM server information to a client process 101 announcing the availability of the VM server 109 for handling compilation requests. The availability of the VM server 109 is handled by a separate thread.

A request handling set of child processes parses 201 incoming requests from each user and loads 202 the parsed requests in a request queue 106. A set of forked child processes handles 203 the loaded requests. A compilation set of forked child processes compiles 204 the software codes and an execution set of forked child processes executes 205 the compiled software codes. Each of the three sets of child processes is forked. The request handling set of forked child processes listens to the compilation and execution requests from each of the multiple client processes 101. The request handling set of forked child processes then accepts and stacks the compilation and execution requests in the request queue 106. The request handling set of forked child processes further separates the requests for compilation and requests for execution of the software codes. The request handling set of forked child processes transfers the execution requests from the request queue 106 to a run request queue and stacks the execution requests in the run request queue. The compilation set of forked child processes handles the loaded requests from the request queue 106 and compiles the software codes corresponding to the handled requests. The compilation set of forked child processes then sends a compilation response back to the client process 101. The execution set of forked child processes handles the run requests from the run request queue and executes the software codes corresponding to the handled run requests. The executed software codes are then loaded 206 on a file system. The execution set of forked child processes then sends an execution response back to the client process 101.

In one implementation of the first computer implemented method for compiling and executing multiple software codes disclosed herein, the software codes are coded, for example, in a C/C++ programming language. In another implementation of the first computer implemented method disclosed herein, the software codes are coded, for example, in a Java® programming language.

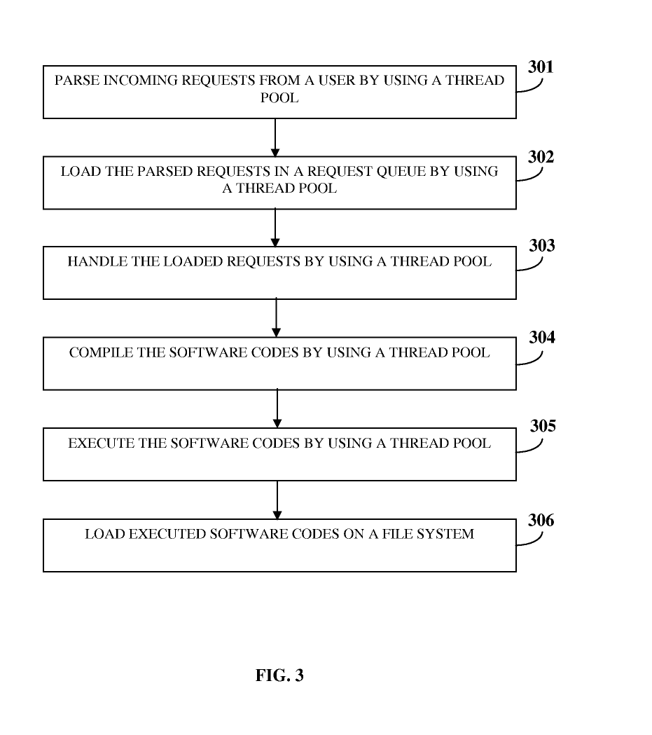

FIG. 3 illustrates a second computer implemented method for compiling and executing multiple software codes using multiple threads. The client processes 101 broadcast requests for availability of the VM server 109, as exemplarily illustrated in FIG. 1, for compiling the software codes. Through a listening port, the VM server 109 continually listens to the broadcasts of requests from the client processes 101. The VM server 109 sends the VM server information to a client process 101 announcing the availability of the VM server 109 for handling compilation requests. The availability of the VM server 109 is handled by a separate thread.

A request handling thread pool is provided in the VM server 109 to handle the incoming compilation and execution requests from the client processes 101. The request handling thread pool continually listens to compilation and execution requests from the client processes 101. The request handling thread pool parses 301 the incoming compilation and execution requests received from a user. The request handling thread pool then loads 302 the parsed requests, that is, accepts and stacks the compilation and execution requests in a request queue 106. The request handling thread pool further separates the compilation and execution requests. The request handling thread pool transfers the execution requests from the request queue 106 to a run request queue and stacks the requests in the run request queue. A compilation thread pool handles 303 the loaded compilation requests from the request queue 106 and compiles 304 the software codes corresponding to the handled requests. The compilation thread pool then sends a compilation response back to the client process 101. An execution thread pool handles 303 the loaded execution requests from the run request queue and executes 305 the software codes corresponding to the handled run requests. The executed software codes are then loaded 306 on a file system. The execution thread pool then sends an execution response back to the client process 101.

In one implementation of the computer implemented system disclosed herein, a compiler in the VM server 109 for compiling the software codes employs a system file cache and a binary cache. The system file cache stores common libraries and system libraries required for the compilation of the software codes. Header files required for compiling software codes coded, for example, in a C or C++ programming language may also be stored in the system file cache. The binary cache stores object files and class files generated as outputs from the compilation of the software codes. The object files are generated when the software codes coded, for example, in a C or C++ programming language are compiled. The class files are generated when software codes coded, for example, in a Java® programming language are compiled. The binary cache is maintained separately for each client process 101. During the compilation of a software code, if a required header or library file is not available on the system file cache, the required header or library file is loaded from a file system to the system file cache. The loaded header or library file is used for current and subsequent compilation of the software codes. The system file cache is updated when a new compilation request, requiring a header or a library file not present in the system file cache, is processed.

During the compilation of a software code coded, for example, in a C or C++ programming language, if a source file of the software code has not undergone modifications since the previous compilation, then the object file stored in the binary cache from the previous compilation of the source file is used for the current compilation of the C or C++ software code. During the compilation of a software code coded, for example, in a Java® programming language, if a source file of the software code has not undergone modifications since the previous compilation, then the class file stored in the binary cache from the previous compilation of the source file is used for the current compilation of the Java software code.

The system file cache and the binary cache are updated with every compilation. For the execution of a C or C++ software code, the required common libraries, system libraries, and the header files stored in the system file cache are linked with the object files in the binary cache to generate an executable file from the software code. For the execution of a Java software code, the required class libraries, system libraries, and other common libraries stored in the system file cache are linked with the class files in the binary cache to generate an executable file from the software code. The final executable files may then be written into a file system.

As disclosed herein, for compiling C or C++ software codes, an open source compiler, for example, an Intel® C++ compiler, a TenDRA® compiler, a GNU compiler collection (GCC), an open Watcom® C compiler, etc., may be used for compilation. For compiling Java software codes, an open source compiler such as the Jikes compiler from IBM, Inc., the Java development kit (JDK) from Sun Microsystems, Inc., an Eclipse® compiler, etc., may be used for compilation. The compilation features described above may be incorporated in such open source compilers.

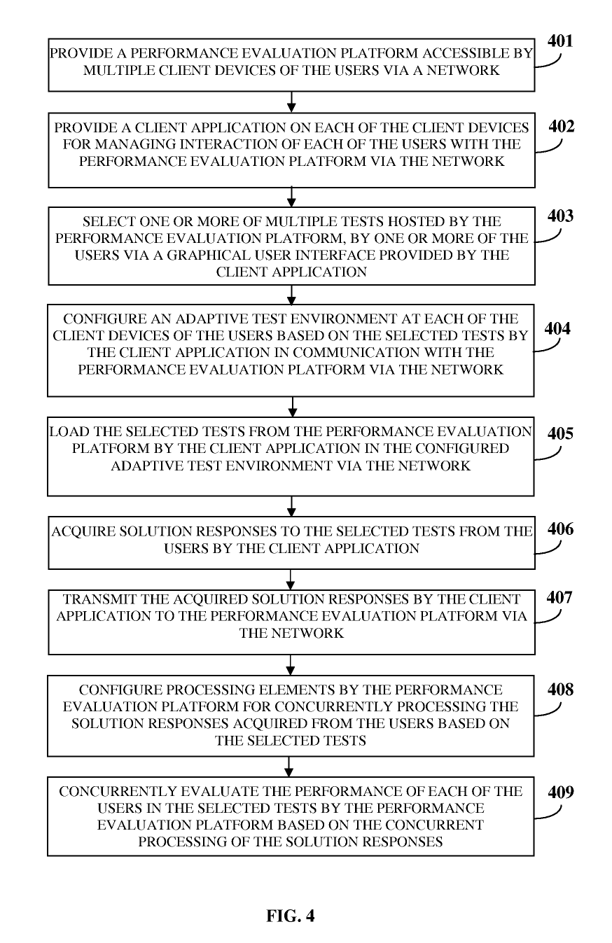

FIG. 4 illustrates a computer implemented method for concurrently evaluating performance of multiple users in one or more tests. The computer implemented method disclosed herein provides 401a performance evaluation platform accessible by multiple client devices of the users via a network. The client devices comprise, for example, personal computers, laptops, tablet computers, mobile communication devices, etc. The network is, for example, the internet, an intranet, a local area network, a wide area network, a communication network implementing Wi-Fi® of the Wireless Ethernet Compatibility Alliance, Inc., a cellular network, a mobile communication network, etc. The performance evaluation platform hosts multiple tests across multiple knowledge domains, for example, information technology (IT) domains, non-IT domains, banking, accounting, etc. The tests comprise, for example, programming tests, database tests, networking tests, banking tests, essay writing tests, assignments, etc. The performance evaluation platform comprises a virtual machine server 109 exemplarily illustrated in FIG. 1. In an embodiment, the performance evaluation platform comprises multiple virtual machine servers 109 that allow a higher concurrency in multiple operations of the performance evaluation platform. The performance evaluation platform monitors connections with the client devices, performs network session management, and manages requests for evaluation of solution responses transmitted by each of the client devices of the users. As used herein, the term “solution response” refers to an answer or a response provided by a user to a particular question or a problem contained in a test. The performance evaluation platform hosts static content, for example, hypertext markup language (HTML) pages, etc., and dynamic content, for example, JavaServer pages (JSP), hypertext preprocessor (PHP) pages, etc.

The computer implemented method disclosed herein provides 402 a client application on each of the client devices of the users for managing interaction of each of the users with the performance evaluation platform via the network. One or more of multiple users select 403 one or more of multiple tests hosted by the performance evaluation platform via a graphical user interface (GUI) provided by the client application on each of the client devices of the users. For example, the client application renders a test selection menu on the GUI that allows the users to select a type of test that they would prefer to take. In another example, the client application receives inputs from the user specifying a technical domain in which the user would like to take a test. The client application stores information on the selection of the test, for example, by tagging the selection to a “test type code”. The test type code identifies the type of test selected by the user and for which the user would be evaluated by the performance evaluation platform. The test type code is defined, for example, by a specific knowledge domain, such as engineering, banking, education, etc., or by a specific skill such as software programming, essay writing, etc. Further, the test type code is attached to each of the solution responses provided by the user for the test. Since each user can take up multiple tests in different knowledge domains, the solution responses to the tests are distinguished by their respective test type codes.

The client application on each of the client devices of the users establishes a connection with the performance evaluation platform via the network. The client application and the performance evaluation platform comprise sockets, for example, a client socket 103 and a server socket 108 respectively, as exemplarily illustrated in FIG. 1, for communicating with each other. The client application on each of the client devices of the user transmits requests querying availability of the performance evaluation platform for triggering initiation of the selected tests. The client application receives connection parameters from the performance evaluation platform via the network for establishing the connection with the performance evaluation platform, on confirming availability of the performance evaluation platform. The connection parameters comprise, for example, the virtual machine (VM) server information disclosed in the detailed description of FIG. 1. The connection parameters uniquely identify the connection between the performance evaluation platform and each of the client devices, specifying, for example, an internet protocol address and a port number of each of the sockets 108 over which the performance evaluation platform listens to the requests for availability of the performance evaluation platform from each of the client devices.

Furthermore, the performance evaluation platform continually monitors requests from the client application on each of the client devices, for example, for establishing a connection with each of the client devices, for concurrently processing the solution responses acquired from the users, etc. The performance evaluation platform employs a separate thread for listening to the requests from the client application on each of the client devices as disclosed in the detailed description of FIG. 1. The client application on each of the client devices exchanges connection messages with the performance evaluation platform for confirming the establishment of the connection as disclosed in the detailed description of FIG. 1. For example, the client application transmits a connection request message to the performance evaluation platform that is acknowledged by the performance evaluation platform, thereby establishing the connection.

The client application, in communication with the performance evaluation platform via the network, configures 404 an adaptive test environment at each of the client devices of the users based on the selected tests. As used herein, the term “adaptive test environment” refers to a test environment that can be configured to accommodate specific features, settings, file formats, software components, etc., necessary for conduction of a particular type of test on a client device. Consider an example where the client application needs to execute an applet, or a Java® application of Oracle Corporation. The configuration of the test environment comprises installing Java Runtime Environment (JRE) for executing the applet or the Java® application.

The performance evaluation platform validates user credentials of the users during the configuration of the adaptive test environment at each of the client devices of the users by the client application. The performance evaluation platform validates session credentials, for example, by authenticating a login user identifier (ID) and a password of each of the users. In an example, the performance evaluation platform allows each of the users to register on the performance evaluation platform for accessing a particular test. The performance evaluation platform collects the user credentials, for example, the user ID and the password of the user. When a user logs in at the performance evaluation platform to take a selected test, the performance evaluation platform compares the user credentials entered by the user during log-in with the user credentials collected during registration and validates the user credentials.

The client application creates a working directory for the users on selection of the tests by the users. The client application downloads a set of startup configuration files necessary for conduction of the selected tests in the working directory. Furthermore, the client application stores the solution responses to the selected tests acquired from the users in the working directory, and automatically uploads the solution responses from the working directory to the performance evaluation platform via the network.

In an embodiment, the client application automatically loads plug-in components from the performance evaluation platform via the network based on the selected tests during configuration of the adaptive test environment at each of the client devices. The plug-in components are software components that provide additional capabilities to the test environment for customizing settings of the test environment to incorporate interfaces, file formats, etc., which are necessary for conduction of the selected tests. The performance evaluation platform provides different plug-in components that can be loaded by the client application for different types of tests, for example, programming tests, database tests, networking tests, banking tests, essay writing tests, etc.

Furthermore, the plug-in components enable configuration of the test environment according to a user's preferences. For example, a plug-in component can configure the settings of a source code editor according to a user's preferences, for example, by providing a command line interface, an integrated development environment (IDE), etc. In another example, a particular test may require a new file format for a programming language that is not supported by the client application. In this case, the client application automatically loads a software program configured to support the new file format. In an embodiment, the performance evaluation platform provides application programming interfaces (APIs) that enable configuration of the plug-in components by third party software developers for supporting new applications. The performance evaluation platform integrates the plug-in components provided by the third party software developers to the performance evaluation platform and allows the client application to automatically load plug-in components from the performance evaluation platform via the network based on the selected tests.

The client application loads 405 the selected tests from the performance evaluation platform, in the configured adaptive test environment, via the network. The tests are, for example, configured by the performance evaluation platform as a set of questions referenced from predetermined question compendia. The question compendia comprise, for example, a set of objective questions testing the knowledge of the users in a particular domain, a set of programming questions that require the users to develop software codes for a specified application or debug faulty software code, etc.

In an embodiment, the performance evaluation platform sets a time duration for the selected tests. The client application triggers a timer on initiation of the time duration set by the performance evaluation platform for the selected tests for timing the performance of each of the users in the selected tests. The client application maintains the timer for computing the amount of time taken by each of the users to complete the test. The timer is, for example, a decreasing timer or an increasing timer. The increasing timer measures the amount of time taken by a user to complete a test. The decreasing timer measures the amount of time starting from a predetermined time count until the time count reaches zero; the user therefore needs to complete the test within a time duration equal to the predetermined time count set at the initiation of the test. That is, the decreasing timer allows a fixed time for completion of the test. Furthermore, the timer can be stoppable or non-stoppable. A stoppable timer stops when the user logs out of the session. The timer is reset and starts again when the user logs in and continues the test. An unstoppable timer does not stop when the user logs out, and continues to count even when the user is not actively working on the test. When the user logs in again, the user is allowed to continue with the test until the timer completes, that is, within a predetermined time count set at the start of the test.

The client application configures the timer for timing a test, for example, using the following pseudocode:

Calculation of displayed time:

If (timed test) is true

Check (increasing or decreasing timer)
If(increasing timer)
Check (Non-stoppable)
If (Non-stoppable)

Display-time = time elapsed since start of the test

If (stoppable)

Display-time = time elapsed

If (decreasing timer)
Check (Non-stoppable or stoppable)
If (Non-stoppable)

Display time = time elapsed since start of the test
If (time elapsed since the start of the test is more than time
given for the test)

Disallow the user from completing the test

If (stoppable)

Display time = time used up by the user.
If (time used up by the user more than time allowed for the
test) then

Disallow the user from completing the test.

The client application on each of the client devices acquires 406 solution responses to the selected tests from the users and transmits 407 the acquired solution responses to the performance evaluation platform via the network. The solution responses comprise, for example, a text file recording the solutions to the questions in the selected test, a source code file for a programming test, etc. For programming tests, the client application acquires, for example, source code files that are compiled and evaluated for compilation errors, run time errors, etc., by the performance evaluation platform.

The performance evaluation platform configures 408 processing elements for concurrently processing the solution responses acquired from the users based on the selected tests. The performance evaluation platform spawns multiple forked child processes, or multiple threads for concurrent processing of the solution responses acquired from the users as disclosed in the detailed description of FIGS. 1-3. The concurrent processing of the solution responses by the performance evaluation platform optimizes the time taken for performing individual steps from the point of acquisition of the solution responses from the client application to the point of transmission of evaluation scores generated by the performance evaluation platform to the client application. For example, the performance evaluation platform provides a caching mechanism comprising a system file cache for storing header files and class libraries, and a binary cache for storing object files and class files for expediting the concurrent processing of the solution responses of the users as disclosed in the detailed description of FIG. 3.

Each set of child processes, or pool of threads are configured for performing a specific functional step for evaluating the performance of the users in the selected tests. The performance evaluation platform acquires the solution responses from the client application on each of the client devices. The performance evaluation platform loads the acquired solution responses in a request queue 106 exemplarily illustrated in FIG. 1. The request queue 106 comprises, for example, a set of solution responses acquired from multiple users for a particular time slot. The solution responses may be from multiple knowledge domains. The solution responses in the request queue 106 are scheduled for processing and evaluation according to a predetermined scheduling policy, for example, a first-in-first-out (FIFO) scheduling policy. The performance evaluation platform parses the acquired solution responses in the request queue 106 for procuring information on the selection of the tests hosted by the performance evaluation platform. For example, the performance evaluation platform obtains the “test type code” that specifies the type of test taken by the user. The performance evaluation platform classifies the parsed solution responses based on the procured information on the selection of the tests. The performance evaluation platform transfers the classified solution responses to solution processing queues associated with the selected tests.

Each solution processing queue forwards the solution responses of a particular test in a particular knowledge domain, for example, to an associated evaluation engine that performs evaluation of the performance of the user in that particular knowledge domain. For example, the solution processing queues dispatch the solution responses acquired from a client device to the respective evaluation engine based on a test type such as a programming test in Java®, C or C++, C#, an open computing language OpenCL™ of Apple Inc., compute unified device architecture CUDA® of Nvidia Corporation, etc. The evaluation engine for a programming test comprises, for example, a compiler as disclosed in the detailed description of FIG. 3, for performing compilation of the software codes acquired as solution responses. In an example, the solution processing queue is a run request queue that directs software codes acquired from the users to a run request handler for execution of the software codes as disclosed in the detailed description of FIG. 1. The performance evaluation platform analyzes the classified solution responses in the associated solution processing queues for assigning an evaluation score to each of the classified solution responses based on evaluation criteria. Each of the steps of processing the solution responses comprising loading the acquired solution responses in a request queue 106, parsing the acquired solution responses, classifying the parsed solution responses, and analyzing the solution responses is performed concurrently, for example, using multiple child processes, multiple threads, etc.

The performance evaluation platform concurrently evaluates 409 the performance of each of the users in the selected tests based on the concurrent processing of the solution responses. The performance evaluation platform performs concurrent evaluation of the performance of each of the users in multiple knowledge domains. For example, the performance evaluation platform can evaluate a user's computer software skills such as proficiency in Microsoft (MS) Office® of Microsoft Corporation, Adobe® Digital Publishing Suite of Adobe Systems, Inc., etc. Further, the performance evaluation platform can evaluate skills of the users in non-engineering domains such as banking, accounting, etc. The performance evaluation platform generates evaluation scores for each of the users based on evaluation criteria and transmits the generated evaluation scores to the client devices of the users via the network. The evaluation criteria for generation of the evaluation scores comprise, for example, time duration for completion of the selected tests by each of the users, accuracy of the solution responses acquired from each of the users, etc. Consider an example where a user selects a formal essay writing test for evaluation by the performance evaluation platform. The performance evaluation platform determines the amount of time taken by the user to complete the test, the number of grammatical errors, spelling errors, logical inconsistencies, etc., in the test, and assigns an evaluation score based on the time taken for completion of the essay and the number of errors detected in the essay. The performance evaluation platform applies predetermined weighting factors to each of the evaluation criteria considered for derivation of the evaluation score.

In an embodiment, the performance evaluation platform computes a relative score based on the generated evaluation scores of each of the users for providing a comparative assessment of the performance of each of the users in the selected tests. Since the performance evaluation platform concurrently evaluates the performance of each of the users in the selected tests, the performance evaluation platform generates a complete list of evaluation scores of the users who have taken a particular test within a specified time slot. The performance evaluation platform applies, for example, a comparative assessment procedure, with the highest rating that identifies the best performer among the users taking the test, and the lowest rating that identifies the worst performer among the users taking the test, to evaluate the performance of each user compared with the performance of the other users who have taken the test within the same time slot.

The performance evaluation platform stores the solution responses acquired from the users and the evaluation scores generated on concurrent evaluation of the performance of each of the users in the selected tests, in a database of the performance evaluation platform for progressively tracking the performance of each of the users in the selected tests over a period of time. The database also stores user information for tracking an association between the user and the solution responses. For example, the performance evaluation platform tracks the number of errors in solution responses, that is, software codes in a series of programming tests taken by a user over a period of time and analyzes the consistency of evaluation scores of the user over the period of time. The performance evaluation platform generates graphical representations for recording a statistical variation in the performance of the user both individually and with reference to other users who have taken up the same test over the period of time. The performance evaluation platform retrieves the evaluation scores tagged against each of the solution responses from the database. The performance evaluation platform generates a report comprising the evaluation scores, a brief description of the methodology for generating the evaluation scores, the relative score of the user with respect to the other users taking the test, etc.

Furthermore, the performance evaluation platform employs a file management system, for example, for managing different versions of the solution responses acquired from the users for progressively tracking the performance of the users. The file management system maintains a history of the solution responses acquired from each user. This allows the user to review the solution responses submitted by the user over a period of time. The performance evaluation platform logs the time of acquisition of the solution responses, the name of the user associated with each solution response, etc., in a log file that is maintained in the file management system.

In an embodiment, the performance evaluation platform adaptively renders questions in the selected tests based on a preliminary set of solution responses acquired from the users. In an example, the performance evaluation platform examines the evaluation scores calculated for a predetermined number of solution responses acquired from a user and increases or reduces the difficulty of the questions rendered in the selected test in real time based on the evaluation scores. In another example, the performance evaluation platform increases or reduces the allowed time duration, or the number of questions for the selected test based on the preliminary set of solution responses acquired from the users.

In an embodiment, the performance evaluation platform provides application programming interfaces (APIs) for enabling development of customized plug-in components by third party applications for evaluating the selected tests. The third party applications comprise, for example, software applications, evaluation tools, etc., developed by third party developers, which can be integrated into the performance evaluation platform. The performance evaluation platform provides application programming interfaces (APIs) that enable configuration of plug-in components by third party developers for evaluating the solution responses. This allows the performance evaluation platform to incorporate different testing methodologies for evaluating the solution responses. Consider an example where the performance evaluation platform comprises a compiler that compiles a solution response that is in the form of a software code of a particular programming language and generates a list of errors and warnings. The performance evaluation platform provides an API that abstracts a computing platform of the performance evaluation platform to different plug-in components. The APIs provide an interface through which the plug-in components can access the solution response for further processing. The plug-in components are, for example, scripts, libraries, etc., provided by a third party developer, for example, an external software development agency, that generate ratings for the severity of the errors, possible consequences, and an overall evaluation score for the software code. The plug-in components can also be customized for different programming languages, applications, etc. The APIs allow the different plug-in components to access the user provided data, for example, solution responses and the data generated by the performance evaluation platform, for example, the compiled source code, scripts, etc. The performance evaluation platform adds on the plug-in component to the compiler allowing a complete evaluation of the software code. Therefore, the third party developers can extend the capabilities of evaluation by the performance evaluation platform via the customized plug-in components developed using the APIs.

The performance evaluation platform provides core services for enabling configuration of the adaptive test environment by the client application and evaluation of the solution responses. The performance evaluation platform provides plug-in components for technologies, for example, the Android™ technology of Google, Inc., for testing skills such as programming in Java®, for knowledge domains such as banking, engineering, etc. The plug-in components are provided for evaluation, for example, of accounting skills, software, PHP, etc. The plug-in components provide additional features to the client application, evaluation engines of the performance evaluation platform, the tests, etc. The plug-in components allow an ecosystem of software developers to build different evaluation methods and systems that allow evaluation of skills, proficiencies, knowledge, etc., across different knowledge domains.

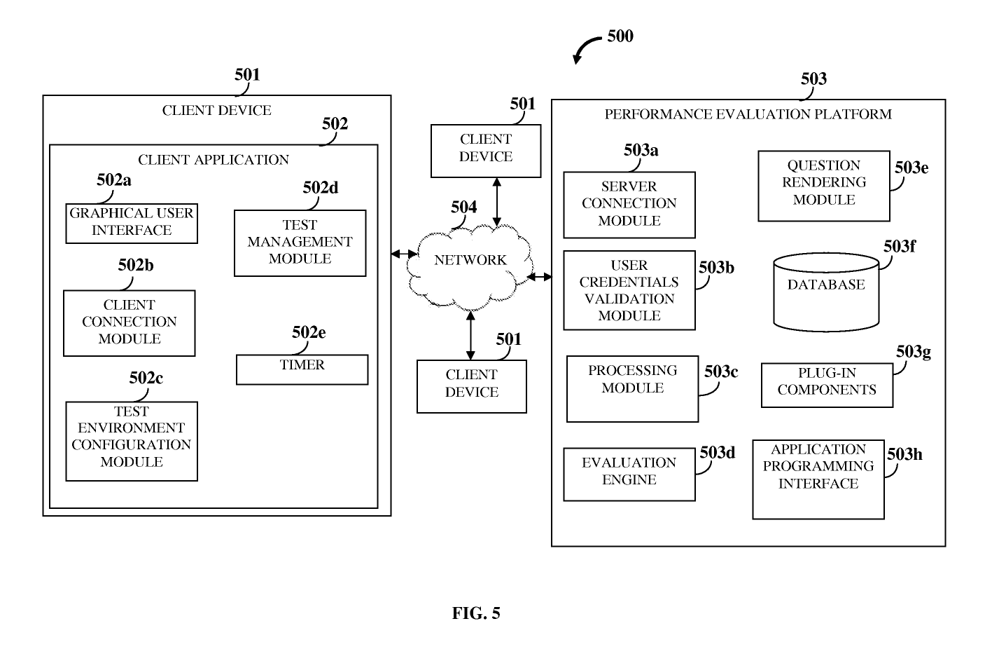

FIG. 5 illustrates a computer implemented system 500 for concurrently evaluating performance of multiple users in one or more tests. The computer implemented system 500 disclosed herein comprises a client application 502 on each of multiple client devices 501 of users and a performance evaluation platform 503 that is accessible by the client devices 501 of the users via the network 504. The client devices 501 comprise, for example, personal computers, laptops, tablet computers, mobile communication devices, etc. The client application 502 manages interaction of each of the users with the performance evaluation platform 503 via a network 504. The client application 502 comprises a graphical user interface 502a, a test environment configuration module 502c, and a test management module 502d.

The graphical user interface (GUI) 502a enables selection of one or more of multiple tests hosted by the performance evaluation platform 503, by one or more users, on each of the client devices 501 of the users. The test environment configuration module 502c, in communication with the performance evaluation platform 503 via the network 504, configures an adaptive test environment at each of the client devices 501 of the users based on the selected tests. The test environment configuration module 502c automatically loads plug-in components 503g from the performance evaluation platform 503 via the network 504 based on the selected tests.

The test management module 502d loads the selected tests in the configured adaptive test environment from the performance evaluation platform 503 via the network 504. The test management module 502d also acquires the solution responses to the selected tests from the users and transmits the solution responses to the performance evaluation platform 503 via the network 504. In an embodiment, the client application 502 further comprises a timer 502e that is triggered on initiation of a time duration set by the performance evaluation platform 503 for the selected tests for timing the performance of each of the users in the selected tests.

The client application 502 further comprises a client connection module 502b that establishes a connection with a server connection module 503a of the performance evaluation platform 503 via the network 504. The client connection module 502b transmits requests querying availability of the performance evaluation platform 503 for triggering initiation of the selected tests. Furthermore, the client connection module 502b receives connection parameters from the performance evaluation platform 503 via the network 504 for establishing the connection with the performance evaluation platform 503, on confirming the availability of the performance evaluation platform 503. The server connection module 503a of the performance evaluation platform 503 continually monitors requests from the client application 502 on each of the client devices 501 for establishing a connection with each of the client devices 501. Furthermore, the server connection module 503a continually monitors requests from the client application 502 on each of the client devices 501 for concurrent processing of the solution responses acquired from the users.

The performance evaluation platform 503 comprises a processing module 503c, an evaluation engine 503d, a user credentials validation module 503b, and a database 503f. The user credentials validation module 503b validates user credentials of the users, during configuration of the adaptive test environment at the client devices 501 of the users by the test environment configuration module 502c of the client application 502. The processing module 503c configures processing elements for concurrently processing the solution responses acquired from the users based on the selected tests. The processing module 503c spawns multiple forked child processes or multiple threads for concurrent processing of the solution responses acquired from the users. The processing module 503c loads the solution responses acquired from the users in a request queue 106 exemplarily illustrated in FIG. 1. The processing module 503c parses the acquired solution responses in the request queue 106 for procuring information on selection of the tests hosted by the performance evaluation platform 503. The processing module 503c classifies the parsed solution responses based on the procured information on the selection of the tests and transfers the classified solution responses to solution processing queues associated with the selected tests.

The evaluation engine 503d concurrently evaluates the performance of each of the users in the selected tests based on the concurrent processing of the solution responses. The performance evaluation platform 503 may comprise one or more evaluation engines 503d for concurrently evaluating the performance of each of the users in the selected tests based on the concurrent processing of the solution responses. The evaluation engine 503d, in communication with the processing module 503c, analyzes the classified solution responses in the associated solution processing queues configured by the processing module 503c, for assigning an evaluation score to each of the classified solution responses based on evaluation criteria, for example, time duration for completion of the selected tests by each of the users, accuracy of the solution responses acquired from each of the users, etc., as disclosed in the detailed description of FIG. 4.

The performance evaluation platform 503 further comprises a question rendering module 503e. The question rendering module 503e generates questions for each of the tests and hosts multiple tests across multiple knowledge domains. The question rendering module 503e adaptively renders questions in the selected tests based on a preliminary set of solution responses acquired from the users. The evaluation engine 503d generates evaluation scores for each of the users based on the evaluation criteria and transmits the generated evaluation scores to each of the client devices 501 of the users via the network 504. In an embodiment, the evaluation engine 503d computes a relative score based on the generated evaluation scores of each of the users for providing a comparative assessment of the performance of each of the users in the selected tests. The database 503f stores, for example, user information, the solution responses acquired from the users, the evaluation scores generated on the concurrent evaluation of the performance of each of the users in the selected tests, etc., for progressively tracking the performance of each of the users in the selected tests over a period of time.

In an embodiment, the performance evaluation platform 503 further comprises an application programming interface (API) module 503h. The API module 503h provides application programming interfaces that enable development of customized plug-in components 503g by third party applications for evaluating the selected tests.

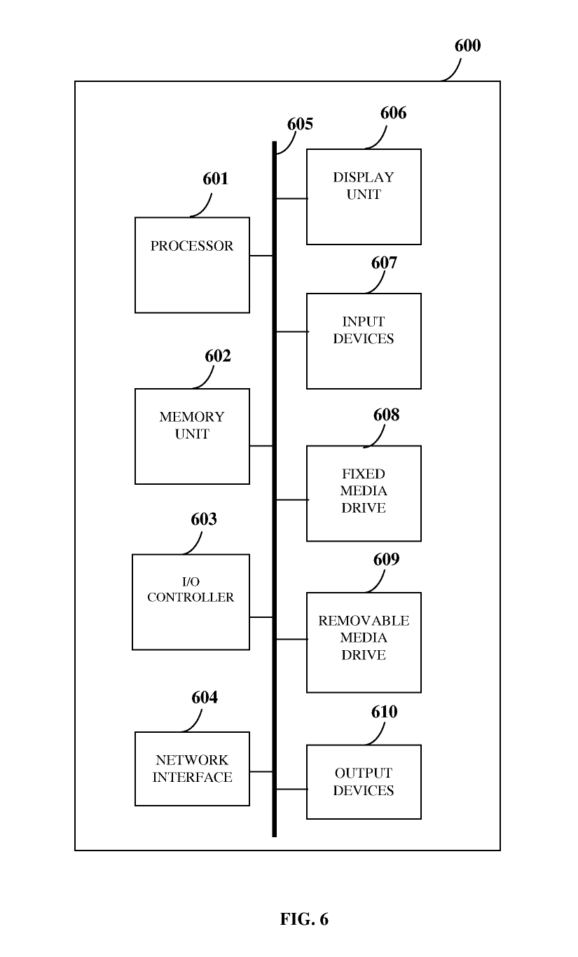

FIG. 6 exemplarily illustrates the architecture of a computer system 600 employed for concurrently evaluating performance of multiple users in one or more tests. The client application 502 on each of the users' client devices 501, exemplarily illustrated in FIG. 5, employs the architecture of the computer system 600, for example, for configuring an adaptive test environment at each of the client devices 501 of the users based on the selected tests, loading the selected tests from the performance evaluation platform 503, and acquiring and transmitting solution responses to the selected tests from the users. The performance evaluation platform 503, exemplarily illustrated in FIG. 5, employs the architecture of the computer system 600, for example, for configuring processing elements for concurrently processing the solution responses acquired from the users based on the selected tests, and for concurrently evaluating the performance of each of the users in the selected tests based on the concurrent processing of the solution responses. The performance evaluation platform 503 and each of the client devices 501 of the computer implemented system 500 exemplarily illustrated in FIG. 5 employ the architecture of the computer system 600 exemplarily illustrated in FIG. 6.

The performance evaluation platform 503 communicates with a client device 501 of each of the users via the network 504, for example, a short range network or a long range network. The network 504 is, for example, the internet, a local area network, a wide area network, a wireless network, a mobile network, etc. The computer system 600 comprises, for example, a processor 601, a memory unit 602 for storing programs and data, an input/output (I/O) controller 603, a network interface 604, a data bus 605, a display unit 606, input devices 607, a fixed media drive 608, a removable media drive 609 for receiving removable media, output devices 610, etc.

The processor 601 is an electronic circuit that executes computer programs. The memory unit 602 is used for storing programs, applications, and data. For example, the client connection module 502b, the test environment configuration module 502c, the test management module 502d, the timer 502e, etc., of the client application 502 are stored in the memory unit 602 of the computer system 600 of the client device 501. The server connection module 503a, the user credentials validation module 503b, the processing module 503c, the evaluation engine 503d, the question rendering module 503e, the database 503f, etc., are stored in the memory unit 602 of the computer system 600 of the performance evaluation platform 503. The memory unit 602 is, for example, a random access memory (RAM) or another type of dynamic storage device that stores information and instructions for execution by the processor 601. The memory unit 602 also stores temporary variables and other intermediate information used during execution of the instructions by the processor 601. The computer system 600 further comprises a read only memory (ROM) or another type of static storage device that stores static information and instructions for the processor 601.

The network interface 604 enables connection of the computer system 600 to the network 504. For example, the client devices 501 of each of the users and the performance evaluation platform 503 connect to the network 504 via the respective network interfaces 604. The network interface 604 comprises, for example, an infrared (IR) interface, an interface implementing Wi-Fi® of the Wireless Ethernet Compatibility Alliance, Inc., a universal serial bus (USB) interface, a local area network (LAN) interface, a wide area network (WAN) interface, etc. The I/O controller 603 controls the input actions and output actions performed by the user using the client device 501. The data bus 605 permits communications between the modules, for example, 502b, 502c, 502d, etc., of the client application 502 on the client device 501 of the user, and between 503a, 503b, 503c, 503d, 503e, etc., of the performance evaluation platform 503.

The display unit 606 of the client device 501, via the GUI 502a, displays information, for example, a selection menu for selecting a particular test, a “start test tab” that enables initiation of the selected test by the user and loading of the individual questions of the selected test, display interfaces, icons, etc., of the adaptive test environment that enable the user to enter the solution responses to the questions of the selected test, the evaluation scores received from the performance evaluation platform 503 on performance of concurrent evaluation of the solution responses acquired from the user, etc.

The input devices 607 are used for inputting data into the computer system 600. The user uses the input devices 607 to select a particular test, initiate the test, and enter the solution responses to the questions of the selected test. The input devices 607 are, for example, a keyboard such as an alphanumeric keyboard, a joystick, a pointing device such as a computer mouse, a touch pad, a light pen, etc. For example, the user can select the test by clicking on a relevant entry in the selection menu using a computer mouse, or can initiate a test by double clicking a “start test tab” on the GUI 502a using a computer mouse.

The output devices 610 output the results of operations performed by the performance evaluation platform 503 and the client device 501 of a particular user. For example, the client device 501 notifies the user that the time duration of the test has ended through an audio alarm notification. In another example where a test based on programming skills is conducted, the client device 501 notifies the user with information regarding failure of compilation of a source code as received from the performance evaluation platform 503 via the GUI 502a of the client application 502.

Computer applications and programs are used for operating the computer system 600. The programs are loaded onto the fixed media drive 608 and into the memory unit 602 of the computer system 600 via the removable media drive 609. In an embodiment, the computer applications and programs may be loaded directly via the network 504. Computer applications and programs are executed by double clicking a related icon displayed on the display unit 606 using one of the input devices 607.

The computer system 600 employs an operating system for performing multiple tasks. The operating system is responsible for management and coordination of activities and sharing of resources of the computer system 600. The operating system further manages security of the computer system 600, peripheral devices connected to the computer system 600, and network connections. The operating system employed on the computer system 600 recognizes, for example, inputs provided by the user using one of the input devices 607, the output display, files, and directories stored locally on the fixed media drive 608, for example, a hard drive. The operating system on the computer system 600 executes different programs using the processor 601.

The processor 601 retrieves the instructions for executing the modules, for example, 502b, 502c, 502d, etc., of the client application 502 on the client device 501 from the memory unit 602. The processor 601 also retrieves the instructions for executing the modules, for example, 503a, 503b, 503c, 503d, 503e, 503f, etc., of the performance evaluation platform 503. A program counter determines the location of the instructions in the memory unit 602. The program counter stores a number that identifies the current position in the program of the modules, for example, 502b, 502c, 502d, etc., of the client application 502, and the modules, for example, 503a, 503b, 503c, 503d, 503e, 503f, etc., of the performance evaluation platform 503.

The instructions fetched by the processor 601 from the memory unit 602 after being processed are decoded. The instructions are placed in an instruction register in the processor 601. After processing and decoding, the processor 601 executes the instructions. For example, the test environment configuration module 502c of the client application 502 defines instructions for configuring an adaptive test environment at each of the client devices 501 of the users based on the selected tests, in communication with the performance evaluation platform 503. The test environment configuration module 502c defines instructions for automatically loading plug-in components 503g from the performance evaluation platform 503 via the network 504 based on the selected tests. The user credentials validation module 503b of the performance evaluation platform 503 defines instructions for validating the user credentials of the users during configuration of the adaptive test environment at each of the client devices 501 of the users.

The client connection module 502b of the client application 502 defines instructions for transmitting requests querying availability of the performance evaluation platform 503 for triggering initiation of the selected tests. The client connection module 502b defines instructions for receiving connection parameters from the performance evaluation platform 503 via the network 504 and using the received connection parameters for establishing a connection with the performance evaluation platform 503, on confirming the availability of the performance evaluation platform 503.

The test management module 502d of the client application 502 defines instructions for loading the selected tests in the configured adaptive test environment from the performance evaluation platform 503 the network 504. The test management module 502d also defines instructions for acquiring and transmitting solution responses to the selected tests from the users, to the performance evaluation platform 503 via the network 504.

The processing module 503c of the performance evaluation platform 503 defines instructions for configuring processing elements for concurrently processing the solution responses acquired from the users based on the selected tests. The processing module 503c also defines instructions for spawning multiple forked child processes or multiple threads for concurrent processing of the solution responses acquired from the users. The processing module 503c also defines instructions for loading the solution responses acquired from the users in a request queue 106 exemplarily illustrated in FIG. 1, and parsing the acquired solution responses in the request queue 106 for procuring information on the selection of the tests. The processing module 503c also defines instructions for classifying the parsed solution responses based on the procured information on the selection of the tests and transferring the classified solution responses to solution processing queues associated with the selected tests.

The server connection module 503a of the performance evaluation platform 503 defines instructions for continually monitoring requests from the client application 502 on each of the client devices 501 for establishing a connection with each of the client devices 501, and for continually monitoring requests for concurrent processing of the solution responses acquired from the users. The evaluation engine 503d of the performance evaluation platform 503 defines instructions for concurrently evaluating the performance of each of the users in the selected tests based on the concurrent processing of the solution responses. The question rendering module 503e of the performance evaluation platform 503 defines instructions for adaptively rendering questions in the selected tests based on a preliminary set of solution responses acquired from the users. The evaluation engine 503d defines instructions for generating evaluation scores for each of the users taking the test based on evaluation criteria and for transmitting the generated evaluation scores to the corresponding client devices 501 of the users via the network 504. Furthermore, the evaluation engine 503d defines instructions for computing a relative score based on the generated evaluation scores of the users for providing a comparative assessment of the performance of each of the users in the selected tests. The evaluation engine 503d defines instructions for analyzing the solution responses in the associated solution processing queues configured by the processing module 503c for assigning an evaluation score to each of the classified solution responses based on evaluation criteria.

The database 503f of the performance evaluation platform 503 defines instructions for storing the solution responses acquired from the users and the evaluation scores generated on concurrent evaluation of the performance of each of the users in the selected tests for progressively tracking the performance of each of the users in the selected tests over a period of time.

The processor 601 of the computer system 600 employed by the client device 501 retrieves the instructions defined by the client connection module 502b, the test environment configuration module 502c, the test management module 502d, etc., of the client application 502 on the client device 501, and executes the instructions. The processor 601 of the computer system 600 employed by the performance evaluation platform 503 retrieves the instructions defined by the server connection module 503a, the user credentials validation module 503b, the processing module 503c, the evaluation engine 503d, the question rendering module 503e, the database 503f, etc., of the performance evaluation platform 503, and executes the instructions.

At the time of execution, the instructions stored in the instruction register are examined to determine the operations to be performed. The processor 601 then performs the specified operations. The operations comprise arithmetic and logic operations. The operating system performs multiple routines for performing a number of tasks required to assign the input devices 607, the output devices 610, and memory for execution of the modules, for example, 502b, 502c, 502d, etc., of the client application 502 on the client device 501, and the modules, for example, 503a, 503b, 503c, 503d, 503e, 503f, etc., of the performance evaluation platform 503. The tasks performed by the operating system comprise, for example, assigning memory to the modules, for example, 502b, 502c, 502d, etc., of the client application 502 on the client device 501, and to the modules, for example, 503a, 503b, 503c, 503d, 503e, 503f, etc., of the performance evaluation platform 503, and to data used by the client application 502 on the client device 501, and the performance evaluation platform 503, moving data between the memory unit 602 and disk units, and handling input/output operations. The operating system performs the tasks on request by the operations and after performing the tasks, the operating system transfers the execution control back to the processor 601. The processor 601 continues the execution to obtain one or more outputs. The outputs of the execution of the modules, for example, 502b, 502c, 502d, etc., of the client application 502 on the client device 501, and the modules, for example, 503a, 503b, 503c, 503d, 503e, 503f, etc., of the performance evaluation platform 503, are displayed to the user on the display unit 606.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 601, except for a transitory, propagating signal.

The computer program product disclosed herein comprises multiple computer program codes for concurrently evaluating the performance of each of multiple users in one or more tests. For example, the computer program product disclosed herein comprises a first computer program code for providing the performance evaluation platform 503 accessible by multiple client devices 501 of multiple users via the network 504; a second computer program code for providing the client application 502 on each of the client devices 501 of the users for managing interaction of each of the users with the performance evaluation platform 503 via the network 504; a third computer program code for enabling selection of one or more tests hosted by the performance evaluation platform 503, by the users via the GUI 502a provided by the client application 502 on each of the client devices 501 of the users; a fourth computer program code for configuring an adaptive test environment at each of the client devices 501 of the users based on the selected tests by the client application 502, in communication with the performance evaluation platform 503 via the network 504; a fifth computer program code for loading the selected tests by the client application 502 in the configured adaptive test environment from the performance evaluation platform 503 via the network 504; a sixth computer program code for acquiring and transmitting solution responses to the selected tests from the users by the client application 502 on each of the client devices 501 of the users to the performance evaluation platform 503 via the network 504; a seventh computer program code for configuring processing elements by the performance evaluation platform 503 for concurrently processing the solution responses acquired from the users based on the selected tests; and an eighth computer program code for concurrently evaluating the performance of each of the users in the selected tests by the performance evaluation platform 503 based on the concurrent processing of the solution responses. The computer program product disclosed herein further comprises additional computer program codes for performing additional steps that may be required and contemplated for performing concurrent evaluation of the performance of each of multiple users in one or more tests.

The computer program codes comprising the computer executable instructions are embodied on the non-transitory computer readable storage medium. The processor 601 of the computer system 600 retrieves these computer executable instructions and executes them. When the computer executable instructions are executed by the processor 601, the computer executable instructions cause the processor 601 to perform the steps of the computer implemented method for concurrently evaluating the performance of each of multiple users in one or more tests. In an embodiment, a single piece of computer program code comprising computer executable instructions performs one or more steps of the computer implemented method disclosed herein for concurrently evaluating the performance of multiple users in one or more tests.

Disclosed herein is also a computer program product comprising a computer program code for providing a request handling set of child processes to parse incoming compilation and execution requests and load the parsed requests in a queue, wherein the request handling set of child processes are forked; a computer program code for providing a request handling thread pool to parse incoming compilation and execution requests and load the parsed requests in a queue; a computer program code for providing a compilation set of child processes to compile multiple software codes, wherein the compilation set of child processes are forked; a computer program code for providing a compilation thread pool to compile multiple software codes; a computer program code for parsing and loading common libraries and system libraries; a computer program code for storing the parsed common libraries and system libraries in a system file cache; a computer program code for parsing and loading the software codes, and linking the parsed software codes with the parsed common libraries and system libraries; a computer program code for providing an execution set of child processes to execute the software codes, wherein the execution set of child processes are forked; a computer program code for providing an execution thread pool to execute the software codes; and a computer program code for loading the executed software codes on a file system.

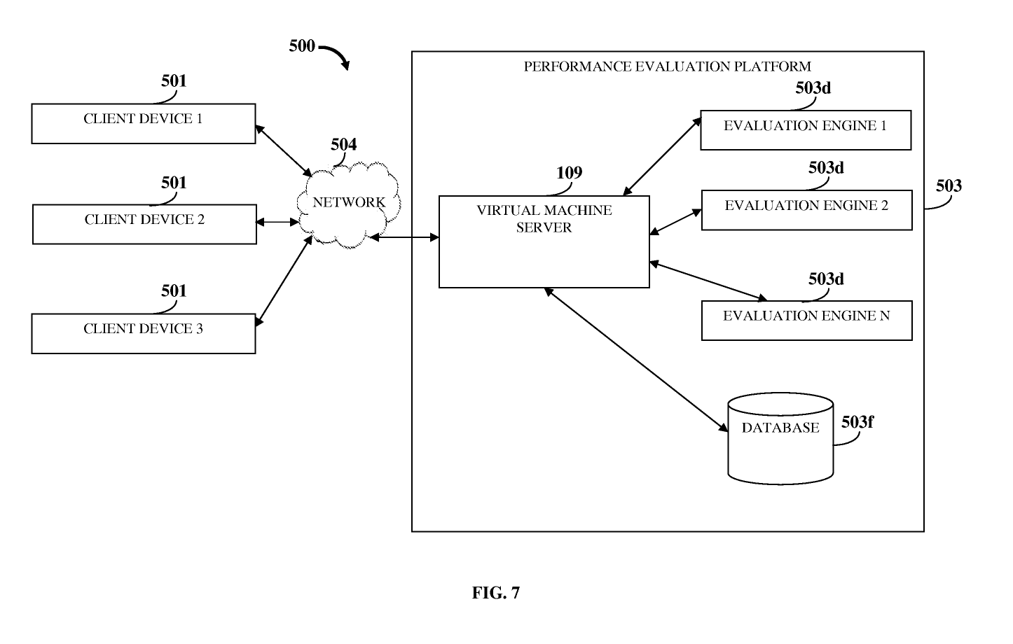

FIG. 7 exemplarily illustrates a high level schematic diagram of the computer implemented system 500 for concurrently evaluating the performance of multiple users in multiple tests. The computer implemented system 500 disclosed herein comprises the performance evaluation platform 503 that evaluates the performance of multiple users in specific tests selected by the users. The users access the performance evaluation platform 503 via the network 504, for example, the internet, using client devices 501, for example, personal computers for taking the test. The performance evaluation platform 503 communicates with each of the client devices 501 via the network 504, for example, the internet. The performance evaluation platform 503 comprises the virtual machine server 109, evaluation engines 503d each of which evaluate the performance of each of the users in a specific knowledge domain and generate evaluation scores, and the database 503f that stores the results of the evaluation, for example, the evaluation scores of the users. The virtual machine server 109 configures separate threads for concurrent processing of the solution responses acquired from the users using the client devices 501. The communication between the virtual machine server 109, the evaluation engines 503d, and the database 503f of the performance evaluation platform 503 is exemplarily illustrated in FIG. 7.

Each of the client devices 501 establishes a connection with the performance evaluation platform 503 via the network 504. The virtual machine server 109 in the performance evaluation platform 503 configures a separate thread for monitoring the establishment of the connection with each of the client devices 501. The performance evaluation platform 503 validates the user credentials comprising, for example, a user identifier and a password of each of the users, and verifies whether the users have registered with the performance evaluation platform 503. Once the performance evaluation platform 503 confirms the identities of the users by validating the user credentials, the performance evaluation platform 503 allows the users to initiate the test. In an example, the users select a test that evaluates the programming skills in the Java® programming language. The type of the test is denoted, for example, by a unique test type code.

The client application 502, exemplarily illustrated in FIG. 5, on each of the client devices 501 performs a preliminary check to verify whether the client device 501 has installed the Java runtime environment (JRE) since the test needs Java® applets to execute correctly. On determining that the JRE is installed on the client device 501, the client application 502 on each client device 501 loads the test from the performance evaluation platform 503. The test comprises a set of start-up configuration files and files comprising the actual questions of the test. The test further comprises additional data on the parameters of the test, for example, the time duration allowed for completion of the test, etc. The client application 502 further checks whether the test needs plug-in components 503g, for example, to support file formats of the loaded files necessary for running the test. The client application 502 loads the required variant of the plug-in component 503g depending on the selected test. The client application 502 loads the files comprising the questions for the test.

The client application 502 creates a working directory for the user for storing the files comprising the questions and the solution responses provided by the users to the questions. The client application 502 starts a timer 502e of duration equal to the time duration specified by the performance evaluation platform 503. The user records the solution responses, for example, a set of programming files, and stores the files in the working directory. The client application 502 checks the time of completion of the test by each of the users and inserts the information along with the test type code to the programming files. The client application 502 retrieves the solution responses, that is, the programming files from the working directory and transmits the programming files along with metadata files to the performance evaluation platform 503 via the network 504.

The performance evaluation platform 503 receives the solution responses, that is, the programming files from all the users taking the test. The virtual machine server 109 in the performance evaluation platform 503 configures a thread pool for parsing the solution responses, thereby ensuring concurrency of processing of the solution responses. Each thread parses a solution response, obtains the test type code, and forwards the solution response to the evaluation engine 503d associated with the test type. For example, the evaluation engine 503d for evaluating programming skills in Java® evaluates the programming files and assigns an evaluation score for each of the programming files submitted by the users. The evaluation engine 503d stores the evaluation scores computed for each of the solution responses in the database 503f, and transmits a report notifying the evaluation scores to each of the client devices 501 of the users. The client devices 501 of the users receive the evaluation report and display the evaluation report on the GUI 502a to the users.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire and fiber optics, including wires that constitute a system bus coupled to a processor. Common forms of computer readable media comprise, for example, a floppy disk, a flexible disk, a hard disk, magnetic tape, any other magnetic medium, a compact disc-read only memory (CD-ROM), a digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as object code. The computer program product disclosed herein comprises computer executable instructions embodied in a non-transitory computer readable storage medium, wherein the computer program product comprises computer program codes for implementing the processes of various embodiments.

Where databases are described such as database 503f, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein.

Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment including a computer that is in communication with one or more devices via a network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, Sun® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for concurrently evaluating performance of a plurality of users in one or more tests, comprising:
providing a performance evaluation platform accessible by a plurality of client devices of said users via a network;
providing a client application on each of said client devices of said users for managing interaction of each of said users with said performance evaluation platform via said network;
selecting one or more of a plurality of tests hosted by said performance evaluation platform, by one or more of said users via a graphical user interface provided by said client application on each of corresponding said client devices of said one or more of said users;
configuring an adaptive test environment at said each of said corresponding said client devices of said one or more of said users based on said selected one or more tests by said client application in communication with said performance evaluation platform via said network;
loading said selected one or more tests from said performance evaluation platform by said client application in said configured adaptive test environment via said network;
acquiring and transmitting solution responses to said selected one or more tests from said one or more of said users by said client application on said each of said corresponding said client devices of said one or more of said users to said performance evaluation platform via said network;
configuring processing elements by said performance evaluation platform for concurrently processing said solution responses acquired from said one or more of said users based on said selected one or more tests; and
concurrently evaluating said performance of each of said one or more of said users in said selected one or more tests by said performance evaluation platform based on said concurrent processing of said solution responses.

2. The computer implemented method of claim 1, wherein said configuration of said adaptive test environment at said each of said corresponding said client devices by said client application comprises automatically loading plug-in components from said performance evaluation platform via said network based on said selected one or more tests.

3. The computer implemented method of claim 1, wherein said concurrent evaluation of said performance of said each of said one or more of said users in said selected one or more tests by said performance evaluation platform comprises generating evaluation scores for said each of said one or more of said users based on evaluation criteria and transmitting said generated evaluation scores to said each of said corresponding said client devices of said each of one or more of said users via said network.

4. The computer implemented method of claim 3, wherein said evaluation criteria for said generation of said evaluation scores by said performance evaluation platform comprise a time duration for completion of said selected one or more tests by said each of said one or more of said users and accuracy of said solution responses acquired from said each of said one or more of said users.

5. The computer implemented method of claim 3, further comprising computing a relative score based on said generated evaluation scores of said each of said one or more of said users for providing a comparative assessment of said performance of said each of said one or more of said users in said selected one or more tests.

6. The computer implemented method of claim 1, wherein said concurrent processing of said solution responses acquired from said one or more of said users by said performance evaluation platform, comprises:
loading said acquired solution responses in a request queue;
parsing said acquired solution responses in said request queue for procuring information on said selection of said one or more of said tests hosted by said performance evaluation platform; and
classifying said parsed solution responses based on said procured information on said selection of said one or more of said tests and transferring said classified solution responses to solution processing queues associated with said selected one or more tests.

7. The computer implemented method of claim 6, wherein said concurrent evaluation of said performance of said each of said one or more of said users in said selected one or more tests by said performance evaluation platform based on said concurrent processing of said solution responses comprises analyzing said classified solution responses in said associated solution processing queues for assigning an evaluation score to each of said classified solution responses based on evaluation criteria.

8. The computer implemented method of claim 1, further comprising setting a time duration for one or more of said selected one or more tests by said performance evaluation platform, wherein said client application triggers a timer on initiation of said time duration for said one or more of said selected one or more tests for timing said performance of said each of said one or more of said users in said one or more of said selected one or more tests.

9. The computer implemented method of claim 1, further comprising adaptively rendering questions in said selected one or more tests based on a preliminary set of said solution responses acquired from said one or more of said users by said performance evaluation platform.

10. The computer implemented method of claim 1, wherein said configuration of said processing elements comprises spawning one of a plurality of forked child processes and a plurality of threads by said performance evaluation platform for said concurrent processing of said solution responses acquired from said one or more of said users.

11. The computer implemented method of claim 1, further comprising establishing a connection by said client application on said each of said corresponding said client devices of said one or more of said users to said performance evaluation platform via said network by performing:
transmitting requests querying availability of said performance evaluation platform by said client application on said each of said corresponding said client devices of said one or more of said users for triggering initiation of said selected one or more tests; and
receiving connection parameters from said performance evaluation platform via said network for establishing said connection with said performance evaluation platform, on confirming said availability of said performance evaluation platform.

12. The computer implemented method of claim 1, further comprising continually monitoring requests from said client application on said each of said corresponding said client devices by said performance evaluation platform for one of establishing a connection with said each of said corresponding said client devices, and said concurrent processing of said solution responses acquired from said one or more of said users.

13. The computer implemented method of claim 1, further comprising validating user credentials of said one or more of said users by said performance evaluation platform during said configuration of said adaptive test environment at said each of said corresponding said client devices of said one or more of said users by said client application.

14. The computer implemented method of claim 1, further comprising storing said solution responses acquired from said one or more of said users and evaluation scores generated on said concurrent evaluation of said performance of said each of said one or more of said users in said selected one or more tests, in a database of said performance evaluation platform for progressively tracking said performance of said each of said one or more of said users in said selected one or more tests over a period of time.

15. The computer implemented method of claim 1, wherein said performance evaluation platform hosts said plurality of said tests across a plurality of knowledge domains.

16. A computer implemented system for concurrently evaluating performance of a plurality of users in one or more tests, comprising:
a client application on each of a plurality of client devices of said users, that manages interaction of each of said users with a performance evaluation platform via a network, wherein said client application comprises:
a graphical user interface that enables selection of one or more of a plurality of tests hosted by said performance evaluation platform, by each of one or more of said users;
a test environment configuration module that configures an adaptive test environment at each of corresponding said client devices of said one or more of said users based on said selected one or more tests, in communication with said performance evaluation platform via said network; and
a test management module that performs:
loading of said selected one or more tests in said configured adaptive test environment from said performance evaluation platform via said network; and
acquiring and transmitting solution responses to said selected one or more tests from said one or more of said users to said performance evaluation platform via said network; and
said performance evaluation platform that is accessible by said client devices of said users via said network, wherein said performance evaluation platform comprises:
a processing module that configures processing elements for concurrently processing said solution responses acquired from said one or more of said users based on said selected one or more tests; and
one or more evaluation engines that concurrently evaluate said performance of said each of said one or more of said users in said selected one or more tests based on said concurrent processing of said solution responses.

17. The computer implemented system of claim 16, wherein said test environment configuration module of said client application automatically loads plug-in components from said performance evaluation platform via said network based on said selected one or more tests.

18. The computer implemented system of claim 16, wherein said one or more evaluation engines generate evaluation scores for said each of said one or more of said users based on evaluation criteria and transmits said generated evaluation scores to said each of said corresponding said client devices of said each of one or more of said users via said network, wherein said evaluation criteria for said generation of said evaluation scores by said performance evaluation platform comprise a time duration for completion of said selected one or more tests by said each of said one or more of said users and accuracy of said solution responses acquired from said each of said one or more of said users.

19. The computer implemented system of claim 16, wherein said processing module performs:
loading said solution responses acquired from said one or more of said users in a request queue;
parsing said acquired solution responses in said request queue for procuring information on said selection of said one or more of said tests hosted by said performance evaluation platform; and
classifying said parsed solution responses based on said procured information on said selection of said one or more of said tests and transferring said classified solution responses to solution processing queues associated with said selected one or more tests.

20. The computer implemented system of claim 19, wherein said one or more evaluation engines in communication with said processing module analyzes said classified solution responses in said associated solution processing queues configured by said processing module, for assigning an evaluation score to each of said classified solution responses based on evaluation criteria.

21. The computer implemented system of claim 16, wherein said client application further comprises a timer that is triggered on initiation of a time duration set by said performance evaluation platform for one or more of said selected one or more tests for timing said performance of said each of said one or more of said users in said one or more of said selected one or more tests.

22. The computer implemented system of claim 16, wherein said performance evaluation platform further comprises a question rendering module that adaptively renders questions in said selected one or more tests based on a preliminary set of said solution responses acquired from said one or more of said users.

23. The computer implemented system of claim 16, wherein said processing module of said performance evaluation platform spawns one of a plurality of forked child processes and a plurality of threads for said concurrent processing of said solution responses acquired from said one or more of said users.

24. The computer implemented system of claim 16, wherein said client application on said each of said corresponding said client devices of said one or more of said users further comprises a client connection module that establishes a connection with said performance evaluation platform via said network, wherein said client connection module performs:
transmitting requests querying availability of said performance evaluation platform for triggering initiation of said selected one or more tests; and
receiving connection parameters from said performance evaluation platform via said network for establishing said connection with said performance evaluation platform, on confirming said availability of said performance evaluation platform.

25. The computer implemented system of claim 16, wherein said performance evaluation platform further comprises a server connection module that continually monitors requests from said client application on said each of said corresponding said client devices for one of establishing a connection with said each of said corresponding said client devices, and said concurrent processing of said solution responses acquired from said one or more of said users.

26. The computer implemented system of claim 16, wherein said performance evaluation platform further comprises a user credentials validation module that validates user credentials of said one or more of said users, during said configuration of said adaptive test environment at said each of said corresponding said client devices of said one or more of said users by said test environment configuration module of said client application.

27. The computer implemented system of claim 16, wherein said performance evaluation platform further comprises a database that stores said solution responses acquired from said one or more of said users and evaluation scores generated on said concurrent evaluation of said performance of said each of said one or more of said users in said selected one or more tests for progressively tracking said performance of said each of said one or more of said users in said selected one or more tests over a period of time.

28. A computer program product comprising computer executable instructions embodied in a non-transitory computer readable storage medium, wherein said computer program product comprises:
a first computer program code for providing a performance evaluation platform accessible by a plurality of client devices of a plurality of users via a network;
a second computer program code for providing a client application on each of said client devices of said users for managing interaction of each of said users with said performance evaluation platform via said network;
a third computer program code for enabling selection of one or more of a plurality of tests hosted by said performance evaluation platform, by one or more of said users via a graphical user interface provided by said client application on each of corresponding said client devices of said one or more of said users;
a fourth computer program code for configuring an adaptive test environment at said each of said corresponding said client devices of said one or more of said users based on said selected one or more tests by said client application in communication with said performance evaluation platform via said network;
a fifth computer program code for loading said selected one or more tests by said client application in said configured adaptive test environment from said performance evaluation platform via said network;
a sixth computer program code for acquiring and transmitting solution responses to said selected one or more tests from said one or more of said users by said client application on said each of said corresponding said client devices of said one or more of said users to said performance evaluation platform via said network;
a seventh computer program code for configuring processing elements by said performance evaluation platform for concurrently processing said solution responses acquired from said one or more of said users based on said selected one or more tests; and
an eighth computer program code for concurrently evaluating said performance of said each of said one or more of said users in said selected one or more tests by said performance evaluation platform based on said concurrent processing of said solution responses.
